(19) United States
(12) Patent Application Publication
(10) Pub. No.: US 2024/0413656 A1
(43) Pub. Date: Dec. 12, 2024

(54) HIGH-RATE BATTERY SYSTEM

(71) Applicant: Nyobolt Limited, Cambridge Cambs (GB)

(72) Inventors: Sheel Sanghvi, Cambridge, MA (US); Himanshu Rai, Cambridge (GB); Steve Hutchins, Cambridge (GB); Sai Shivareddy, Cambridge (GB)

(21) Appl. No.: 18/706,629

(22) PCT Filed: Nov. 3, 2022
(86) PCT No.: PCT/EP2022/080677

§ 371 Date: May 1, 2024

(30) Foreign Application Priority Data
Nov. 3, 2021 (GB) 2115818.3

(51) Int. Cl. H02J 7/00; H01M 10/42; H01M 10/44

(52) U.S. Cl. CPC H02J 7/0063; H01M 10/425; H01M 10/441; H02J 7/0069; H02J 7/007182; H02J 2207/20

(57) ABSTRACT

The invention relates to a battery comprising a power conditioning circuit operable to condition power discharged from a plurality of connected cells to provide an output voltage range narrower than the input voltage of the plurality of connect cells. The invention also relates to a method of discharging a high-rate energy storage system comprising discharging, using a power conditioning circuit, a plurality of connected cells in a first voltage range, conditioning power discharged from the plurality of connected cells to provide an output voltage in a second range, wherein the second range is smaller than the first range on a per cell basis. The power conditioning circuit may comprise a dual-stage boost converter coupled to a plurality of connected cells. The battery can be used to discharge cells over a wide cell voltage range and provide a narrower and more usable voltage range to a load, to facilitate fast cell cycling.

### RELATED APPLICATIONS

The present case claims priority to, and the benefit of, GB 2115818.3 filed on 3 Nov. 2021 (03.11.2021), the contents of which are hereby incorporated by reference in their entirety.

### TECHNICAL FIELD OF THE INVENTION

Disclosed is a battery comprising a power conditioning circuit to provide a high-rate battery system, and a method of discharging a high-rate battery.

### BACKGROUND

Batteries are available in a variety of types and sizes and are used as electrical power sources in a range of portable devices. For high-rate applications, such as battery-powered tools, there remains a need to provide a battery that is capable of providing higher rate discharge.

### SUMMARY OF INVENTION

Generally, the invention relates to a battery comprising a power conditioning circuit operable to condition power discharged from a plurality of connected cells to provide an output voltage range narrower than the voltage range of the plurality of connected cells.

In a first aspect, the invention provides a battery comprising:
a plurality of connected cells;
a power conditioning circuit coupled to the plurality of connected cells,
   wherein the power conditioning circuit is operable to discharge the plurality of connected cells in a first range, the first range defined as a difference between an upper per cell voltage to a lower per cell voltage,
   wherein the power conditioning circuit is operable to condition power discharged from the plurality of connected cells to provide an output voltage in a second range, wherein the second range is smaller than the first range on a per cell basis; and
output terminals electrically connected to the power conditioning circuit for providing the output voltage to a load.

Embodiments are directed to a high-rate battery.

Generally, the invention also relates to a method of discharging a battery comprising discharging a battery using a power conditioning circuit to provide an output voltage range narrower than the voltage range of the plurality of connected cells. A non-limiting example includes discharging, using a power conditioning circuit, a plurality of connected cells in a first range, the first range defined as a difference between an upper per cell voltage to a lower per cell voltage; conditioning power discharged from the plurality of connected cells to provide an output voltage in a second range, wherein the second range is smaller than the first range on a per cell basis; and outputting the output voltage to a load.

In a second aspect, the invention provides a method of discharging a battery comprising:
discharging, using a power conditioning circuit, a plurality of connected cells in a first range, the first range defined as a difference between an upper per cell voltage to a lower per cell voltage;
conditioning power discharged from the plurality of connected cells to provide an output voltage in a second range, wherein the second range is smaller than the first range on a per cell basis; and
outputting the output voltage to a load.

In one embodiment, the battery is a component of a high rate energy storage system.

The first range is typically the difference between the upper per cell voltage and the lower per cell voltage of the cell. This refers to the voltage of the cell itself, before any power conditioning (i.e. without power conditioning). In other words, first range=upper per cell voltage of the cell−lower per cell voltage of the cell. The upper per cell voltage may be the per cell voltage when the cell is at a 100% state of charge (SOC). That is, the upper per cell voltage is typically the highest voltage produced by the cell. The lower per cell voltage may be the per cell voltage when the cell is at a 0% state of charge (SOC). That is, the lower per cell voltage is typically the lowest voltage produced by the cell. The first range may also be referred to as the “input” range.

The second range is typically the difference between the upper per cell voltage and lower per cell voltage provided to the load. This refers to the voltage after power conditioning (i.e. after the power conditioning by the power conditioning circuit). This may also be the voltage of the output from the power conditioning circuit. The voltage is also that provided to the load after power conditioning. In other words, the second range=upper per cell voltage provided to the load−lower per cell voltage provided to the load. The upper per cell voltage provided to the load may be achieved when the cell is providing the upper per cell voltage of the cell (e.g. when the cell is at a 100% state of charge (SOC)). The lower per cell voltage provided to the load may be achieved when the cell is providing the lower per cell voltage of the cell (e.g. when the cell is at a 0% state of charge (SOC)). The second range may also be referred to as the “output” range.

The second range is smaller than the first range on a per cell basis. That is, the magnitude of the second range is less than the first range.

The end points of the second range (upper or lower per cell voltage provided to the load) may be outside or inside the end points of the first range (upper or lower per cell voltage of the cell). The upper end point of the second range (upper per cell voltage provided to the load) may be less than the upper end point of the first range (upper per cell voltage of the cell). The lower end point of the second range (lower per cell voltage provided to the load) may be more than the lower end point of the first range (lower per cell voltage of the cell). Preferably, the upper and lower end points of the second range are inside the upper and lower end points of the first range. More preferably, one end point of the second range is encompassed by the end points of the first range. In this case, preferably the upper end point of the second range is greater than upper end point of the first range.

The power conditioning circuit may be operable to increase the output voltage provided to the load when a per cell voltage of the plurality of connected cells is less than a first threshold voltage. The power conditioning circuit may include a boost converter to increase the output voltage provided to the load. The boost converter is typically operable to increase the output per cell voltage to a load compared to the per cell voltage of the plurality of connected cells, such as when a per cell voltage of the plurality of connected cells is less than a first threshold voltage

The power conditioning circuit may be operable to decrease the output voltage provided to the load when a per cell voltage of the plurality of connected cells is greater than a second threshold voltage. The power conditioning circuit may include a buck converter to decrease the output voltage provided to the load. The buck converter is typically operable to decrease the output per cell voltage to a load compared to the per cell voltage of the plurality of connected cells, such as when a per cell voltage of the plurality of connected cells is greater than a second threshold voltage.

Preferably, the power conditioning circuit is operable to increase the output voltage provided to the load when a per cell voltage of the plurality of connected cells is less than a first threshold voltage and is operable to decrease the output voltage provided to the load when a per cell voltage of the plurality of connected cells is greater than a second threshold voltage. The power conditioning circuit may include a buck converter to decrease the output voltage and a boost converter to increase the output voltage provided to the load.

In this way, the power conditioning circuit is operable to decrease or increase the voltage depending on the input voltage of the cell. The input voltage of the cell may be compared to the threshold voltages (e.g. predetermined threshold voltages). This allows for improved battery utilization and efficiency. This differs from known systems where the power conditioning circuit is operable depending on the demands of the load or signals from the load.

The power conditioning circuit may be in a non-conditioning mode when the per cell voltage of the plurality of connected cells is between the first threshold voltage and the second threshold voltage.

The battery may comprise a battery pack housing containing the plurality of connected cells and the power conditioning circuit. In other words, the power conditioning circuit may be integral to the battery.

The plurality of connected cells may be connected in series, in parallel or a combination thereof. In some embodiments, the plurality of connected cells are two or more cells connected in series, such as three or more cells in series, four or more cells in series, six or more in series. Preferably, the plurality of connected cells are from two to ten cells connected in series, more preferably four to eight cells in series, even more preferably five to seven cells in series.

In some embodiments, the plurality of connected cells are two or more banks of cells connected in parallel, wherein the two or more banks of cells are two or more cells connected in series. Preferably, the plurality of connected cells are two banks of cells connected in parallel, wherein the two banks of cells are two or more cells connected in series, preferably from two to ten cells connected in series, more preferably four to eight cells in series, even more preferably five to seven cells in series. Particularly preferably, the plurality of connected cells are two banks of cells connected in parallel, wherein the two banks of cells are two cells connected in series.

Other embodiments implement features of the above-described method in a system and a device.

Embodiments are also directed to a battery including a plurality of connected cells and a dual-stage boost converter coupled to the plurality of connected cells. The dual-stage boost converter comprises a controller; and a first boost converter and a second boost converter that are coupled to the power source and are in parallel to each other. The first boost converter and the second boost converter are operably coupled to the controller. The first boost converter is configured to generate a power signal to operate the second boost converter, and the second boost converter is configured to boost an input voltage from the power source to provide an output voltage to a load when the second boost converter receives the power signal from the first boost converter. The dual-stage boost converter allows for very low input voltages to be stepped up to much higher output voltages. The dual stage boost converter allows for large voltage step ups to be conducted more efficiently.

Additional technical features and benefits are realized through the disclosed techniques. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a block diagram of components of a high-rate energy storage system in accordance with one or more embodiments;

FIG. 2 illustrates an example voltage profile for a battery cell used in the high-rate energy storage system in accordance with one or more embodiments;

FIG. 3 illustrates a circuit diagram for a power conditioning circuit having a boost converter circuit used in the high-rate energy storage system in accordance with one or more embodiments of the invention;

FIG. 4 illustrates an example power conditioning circuit having a buck converter circuit used in the high-rate energy storage system in accordance with one or more embodiments of the invention;

FIG. 5 illustrates an example power conditioning circuit having a buck-boost converter circuit used in the high-rate energy storage system in accordance with one or more embodiments of the invention;

FIG. 6 illustrates an example power conditioning circuit having a dual-stage boost converter circuit used in the high-rate energy storage system in accordance with one or more embodiments of the invention;

FIG. 7 illustrates an example battery pack 600 incorporating the buck-boost converter circuit within the battery pack housing in accordance with one or more embodiments of the invention; and

FIG. 8 illustrates a flowchart of a method for discharging the high-rate energy storage system in accordance with one or more embodiments of the invention.

The diagrams depicted herein are illustrative. There can be many variations to the diagrams or the operations described therein without departing from the spirit of this disclosure. For instance, the actions can be performed in a differing order or actions can be added, deleted, or modified. Also, the term “coupled” and variations thereof describes having a communications path between two elements and does not imply a direct connection between the elements with no intervening elements/connections between them. All of these variations are considered a part of the specification.

### DETAILED DESCRIPTION OF THE INVENTION

One or more embodiments provide a high-rate battery that is operable to discharge energy over a wide voltage range. Batteries can be used to provide electrical energy for different applications ranging from power tools to electrical vehicles. The rate at which the electrical energy is provided to the load can be a function of the type and size of the power source or power supply used for each specific application. In accordance with one or more embodiments, a battery pack is integrated with a power conditioning circuit to discharge energy to the load at a high rate. The power conditioning circuit is operable to step down the voltage when an upper threshold is reached and is further operable to step up the voltage when a lower threshold is reached. As a result, the output voltage range remains in a narrow and usable range across a large range of input (cell) voltages.

The combination of the plurality of connected cells coupled with the power conditioning circuit is used to recapture the remaining capacity of the battery cells that would otherwise remain unused. In known systems, when the cell voltage is reduced (e.g. at low SOC), the relatively low cell voltage results in a low output voltage, so the power is not usable by the load which may only operate in a narrow voltage window. However, in the present invention the low cell voltage (e.g. at low SOC) may be stepped up to increase the output voltage to the load. Thus, a larger proportion of the cell voltage range is usable by the load. This results in an increase in the efficiency of the energy storage system.

This improvement is particularly relevant to high rate batteries which operate across a large voltage range. For example, niobium oxide-based battery cells typically have a voltage range of from 0.5V to 3.2V, such as from 0.6V to 3.1V, or such as from 0.7V to 3.0V. The large voltage range means that a load may normally only be able to use the battery for a portion of the voltage range, reducing the usable capacity of the cell. However, the present invention conditions the power from the cell to provide a smaller output voltage range. As a result, the full range of the cell's voltage is usable by the load and so the cell has a higher usable capacity. The load may use power from the cell from about 100% to 0% SOC.

Current technologies such as available lithium-ion cells are incapable of performing a fast charge and/or discharge over a long cycle life. Lithium-ion battery cells are generally limited to operating over a range of 3 to 4.2V. Niobium oxide-based battery cells can provide a higher rate of charge/discharge and operate at a lower voltage than lithium-ion cells using a carbonaceous negative electrode active material. In addition, the niobium oxide-based battery cells have a wider voltage range between a fully charged state and a discharged state. The present invention may also allow alternative batteries (e.g. niobium oxide-based cells) to be used in devices adapted for traditional lithium-ion cells, by adjusting the voltage of the alternative (e.g. niobium oxide-based cell) cell to replicate that of a traditional lithium-ion cell.

EP 2685635 describes a mobile terminal device with a power converter including a buck-boost converter to change the output voltage. The document describes increasing and decreasing the voltage of the cell to suit different components of the device, using multiple power management integrated circuits (PMICs). Different output voltages are provided to different components. The document does not disclose that the output voltage range to a load is smaller on a per cell basis than the input voltage from the cells.

WO 2005/060023 relates to a constant output voltage battery module, which can compensate for single cell failure in a battery module by stepping up the output voltage to account for the cell failure. WO 2005/060023 also concerns providing a monoblock battery construction that supplies voltage over a range wider than that defined by the potential of the electrochemical cells, meaning the output range to the load is not smaller than the input voltage from the cells. The document is not concerned with increasing the usable voltage range of a cell, especially not a niobium oxide-based cell.

US 2019/0305586 is a backup energy device for a computing device. The device includes a buck-boost converter to regulate the output voltage in response to the demand of the computing device. The output voltage is determined by the computing device and not the battery itself, and the output voltage range is not smaller than the input voltage. The document does not concern improving the usable voltage range of the battery, and especially not a niobium oxide containing cell.

US 2017/0126131 describes a specific circuit to provide a low-voltage driver for a field effect transistor (FET). The document concerns reducing excessive voltage consumed by the circuitry. It does not concern improving the usable voltage range of the cell, such as a niobium oxide containing cell. US 2017/0126131 describes a circuit wherein the buck and boost converter circuits are provided in separate circuits. The present invention may include the buck-boost converter in the same circuit.

US 2013/0320932 describes a specific circuit aiming to reduce the number of switches required to increase or decrease current by using an inductor as a buck or boost converter. The document does not concern improving the usable voltage range of the battery.

US 2013/0043839 concerns a battery system which can tolerant different battery chemistries. The present invention may use a single battery chemistry, such as a niobium oxide-based battery. The document does not relate to improving the usable voltage range of the battery.

US 2010/0156175 and U.S. Pat. No. 7,702,369 relates to systems including a battery and a boost converter to step up the voltage of the battery. Thus, the output voltage to the load can only be more than or equal to the input voltage from the battery. The present invention may include a buck and boost converter to step down and step up the battery voltage, in order to provide a smaller output voltage range than the input voltage range. US 2010/0156175 and U.S. Pat. No. 7,702,369 do not relate to improving the usable voltage range and do not describe niobium oxide-based cells. U.S. Pat. No. 7,702,369 is specific to a wireless computer mouse, and the boost converter is only activated when the wireless signal fails.

Generally, the present invention uses an internal power conditioning circuit, which is part of the battery. The output voltage is determined by the internal power conditioning circuit and the battery voltage thresholds. The prior art systems described in EP 2685635, US 2013/0043839, U.S. Pat. No. 7,702,369 and US 2019/0305586 instead use external signals and power conditioning to determine the output voltage. In addition, none of the prior art discussed above use a niobium oxide-based battery.

One or more embodiments address one or more of the above-described shortcomings of the prior art by integrating a power conditioning circuit with a battery pack comprising niobium oxide-based cells. Embodiments can include switch-mode converters including any combination of buck converters, boost converters, or buck-boost converters to regulate the output voltage. Particularly, one or more embodiments are configured to use a power conditioning circuit to regulate the voltage that is provided to the load, which is in contrast to contemporary energy storage systems where the output voltage is provided to the load over a limited range. For example, current lithium-ion cells are limited to cycle between the range of approximately 3V to 4.2V. On the other hand, niobium oxide-based battery cells for the techniques described herein provide a wider range, e.g., 0.5V, 0.6V, or 0.7V to 3.2V, 3.1V, or 3V. The first range may be from 0.5V to 3.2V, preferably from 0.6V to 3.1V, more preferably from 0.7V to 3.0V. Thus, the niobium oxide-based battery cells provide a cell voltage range of greater than 2V, e.g., 2.7V, 2.6V, or 2.5V. Also, because the disclosed battery includes a power conditioning circuit that includes a buck-boost converter, the output voltage can be stepped-up and stepped-down to utilize the wider operable voltage range of the niobium oxide-based cells to provide greater energy.

One or more embodiments provide a technical solution to one or more of these disadvantages of existing solutions by integrating the niobium oxide-based cells with a power conditioning circuit to maximize the output over the entire voltage range of the battery cells.

The plurality of connected cells may comprise a niobium oxide-based cell. That is, the cells comprise a niobium oxide material as an electrode active material. The plurality of connected cells may consist essentially of niobium oxide-based cells. The niobium oxide-based cell typically has a niobium oxide material as one of the negative electrode active materials. The negative electrode active material is the anode during galvanic discharge. The niobium oxide material may be a niobium oxide, a niobium metal oxide, a niobium metalloid oxide, a niobium phosphorous oxide, or a niobium chalcogenide, wherein the chalcogenide includes oxygen, as described below. Preferably the niobium oxide material is a niobium metal oxide, such as a niobium tungsten oxide.

Preferably, the niobium oxide material is the negative electrode active material. In other words, the niobium-oxide electrode active material is the anode during discharge (e.g. galvanic discharge) of the electrochemical cell.

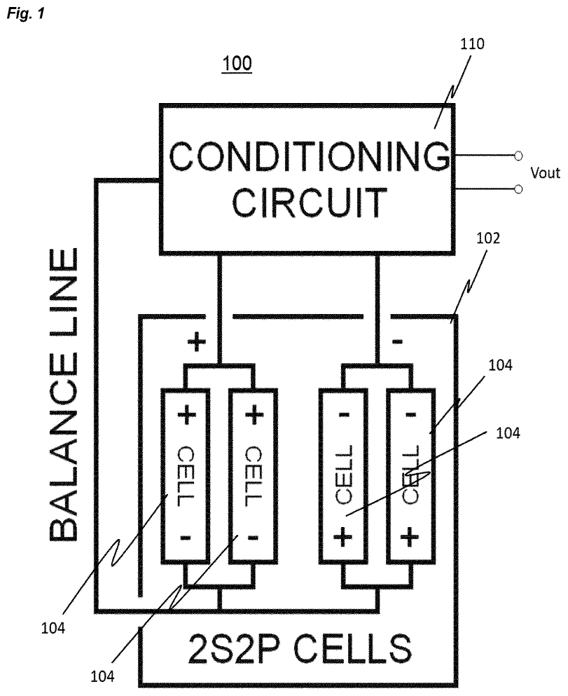

Turning now to FIG. 1, an example high-rate energy storage system 100 is shown in accordance with one or more embodiments. The high-rate energy storage system 100 includes a battery pack 102 having a plurality of battery cells 104 and a power conditioning circuit 110. The battery pack 102 is electrically coupled to the power conditioning circuit 110. However, in other embodiments, the power conditioning circuit 110 can be integrated within the battery pack 102. Although the battery pack 102 includes 4 battery cells, it can be appreciated that any number of battery cells 104 can be incorporated in the battery pack 102 and is not limited to 4 battery cells. Each battery cell 104 is characterized by an upper per cell voltage and a lower per cell voltage which defines a discharge voltage range for each battery cell 104. For example, a niobium oxide material-based cell can be discharged from a range of 3.2V to 0.5V, which provides a greater voltage range, e.g., 2.8V, than that provided by lithium-ion cells that use a carbonaceous anode.

The niobium oxide-based cell has an anode active material comprising a niobium oxide material comprising at least one of niobium oxide, a niobium metal oxide, a niobium metalloid oxide, a niobium phosphorous oxide, or a niobium chalcogenide, wherein the chalcogenide includes oxygen. The niobium oxide material may comprise niobium, oxygen, and at least one of Na, Mg, Al, Si, P, S, K, Ca, Ti, V, Cr, Mn, Fe, Co, Ni, Cu, Zn, As, Y, Zr, Mo, In, Sn, Sb, Ta, or W. The niobium oxide may be Nb₂O₅, and the niobium metal oxide may comprise Nb and at least one of Ti, V, Cr, Mo, Ta, or W. In the niobium metal oxide, a mole ratio of niobium to the metal, e.g., Nb:M, wherein the metal M may be at least one of Ti, V, Cr, Mo, Ta, or W, may be 0.1, 0.2, 0.5, or 1 to 2, 3, 4, 5, 8, 10, or 12, based on a total content of niobium and the metal. A niobium metal oxide comprising Nb and W or Mo is mentioned. The niobium oxide material may comprise at least one of Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, Nb₂W₁₅O₅₀, Nb₂WO₈, Nb₂Mo₃O₁₄, Nb₁₄Mo₃O₄₄, Nb₁₂MoO₄₄, Nb₂TiO₇, Nb₁₀Ti₂O₂₉, or Nb₂₄TiO₆₂. Preferably, the niobium oxide material is selected from Nb₁₆W₅O₅₅, Nb₁₈W₁₆O₉₃ and combinations thereof. A combination comprising at least one of foregoing may be used. It can be appreciated that the list of example niobium oxides materials is not intended to limit the scope of the invention but are listed to provide illustrative examples for the niobium oxides and niobium metal oxides.

The cathode active material may be a lithium metal oxide, wherein the metal is a transition metal such as Co, Fe, Ni, V or Mn, or combination thereof. Examples include lithium cobalt oxide (LiCoO₂), lithium nickel manganese cobalt oxide (NMC, LiNiMnCoO₂, e.g. LiNi_{0.6}Coo₂Mn_{0.2}O₂), lithium vanadium fluorophosphate (LiVPO₄F), lithium nickel cobalt aluminum oxide (NCA, LiNiCoAlO₂), lithium iron phosphate (LFP, LiFePO₄), or manganese-based spinels (e.g. LiMn₂O₄).

The electrolyte may be a non-aqueous electrolyte. The electrolyte may comprise a polar aprotic organic solvent and a lithium salt. Suitable solvents and salts for the electrolyte can be determined by one of skill in the art without undue experimentation. Mentioned is a solution of LiPF₆ in a mixture of carbonates, such as ethylene carbonate, dimethyl carbonate, or ethyl methyl carbonate.

The electrochemical cell may also include a porous membrane between the negative and positive electrodes. The porous membrane may comprise a polymer, e.g., polyethylene, polypropylene, or a copolymer thereof.

Additional details of the niobium oxide-based cell are disclosed in U.S. Patent Publication No. 2021/0218075, the content of which is incorporated herein by reference in its entirety.

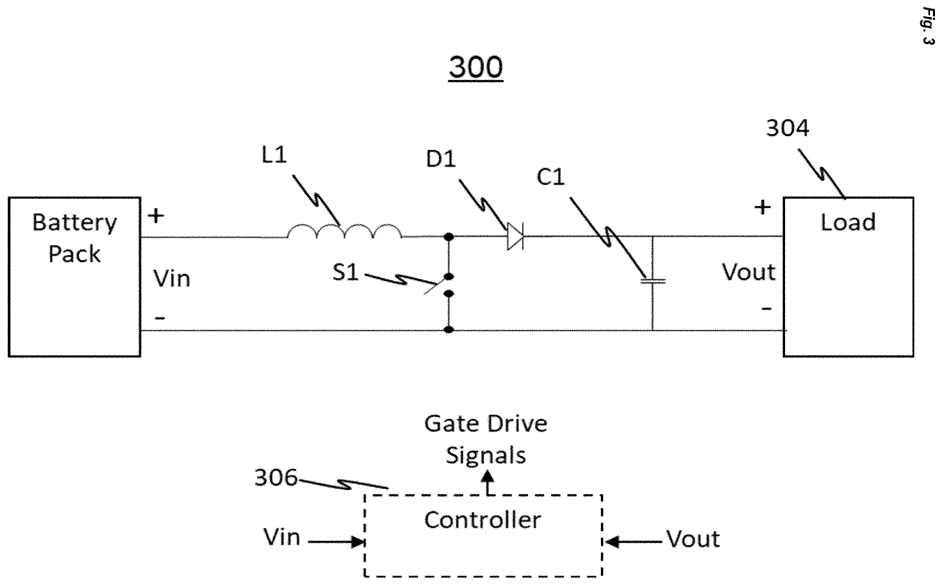

FIG. 1 depicts a power conditioning circuit 110. The power conditioning circuit 110 can include DC-DC converters of different topologies comprising, for example, buck converters, boost converters, or buck-boost converters. The details of the various topologies are discussed with reference to FIGS. 3-5 below. The power conditioning circuit 110 is configured to discharge a plurality of connected cells of the battery pack 102 in a first range, where the first range is defined as a difference between an upper per cell voltage to a lower per cell voltage. The power conditioning circuit 110 is operable to condition the power discharged from the plurality of connected cells to provide an output voltage in a second range to a load that is coupled to the high-rate energy storage system 100 (not shown), where the second range is smaller than the first range on a per cell basis. For example, for a battery pack 102 comprising four cells, the power conditioning circuit 110 provides power at a desired output voltage. To determine the output voltage for the second range on a per cell basis, the output voltage is divided by the number of cells in battery pack 102. In this example, the output voltage is divided by the four cells of battery pack 102 to determine the second range on a per cell basis. It can be appreciated that the battery pack 102 is not limited to four battery cells but can comprise any number of batteries such as 2, 4, 8, etc.

In one or more embodiments, the first range is or equal to 1.8V per cell, greater than 2V per cell, e.g., 2.7V, 2.6V, or 2.5V per cell, which is greater than that provided by current lithium-ion cells, and the second range for an output voltage provided by the power conditioning circuit 110 is less than or equal to 1V per cell. The first range is different than the second range. In other embodiments of the invention, battery cells such as LiFePO₄/NbWO-based cells can have an upper per cell voltage of at least 2.7V per cell and the lower per cell voltage is 0.5V per cell, while providing an output voltage in a second range from 4.2V per cell to 3V per cell.

In further embodiments of the invention, battery cells such as LCO/NbWO-based cells can be discharged by the power conditioning circuit 110 from an upper per cell voltage of 3.3V per cell to a lower per cell voltage of 0.5V per cell. In different embodiments of the invention, battery cells such as LMO/NbWO-based cells can be discharged by the power conditioning circuit 110 from an upper per cell voltage of 3.7V per cell to a lower per cell voltage of 0.5V per cell.

Preferably, the first range is greater than or equal to 1.8V per cell, more preferably greater than or equal to 2.0V per cell. Preferably, the upper per cell voltage provided by the cell is at least 2.7V per cell, more preferably at least 2.9V per cell, even more preferably at least 3.0V per cell. Preferably, the lower per cell voltage provided by the cell is 0.8V or less per cell, more preferably 0.7 V or less per cell, even more preferably 0.6V or less per cell.

Preferably, the second range is less than or equal to 1.5V per cell, more preferably less than or equal to 1.0V per cell. Preferably, the upper per cell voltage output from the power conditioning circuit is 4.5V or less per cell, more preferably 4.3V or less per cell, even more preferably 4.2V or less per cell. Preferably, the lower per cell voltage output from the power conditioning circuit is 2.7V or more per cell, more preferably 2.9V or more per cell, even more preferably 3.0V or more per cell.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

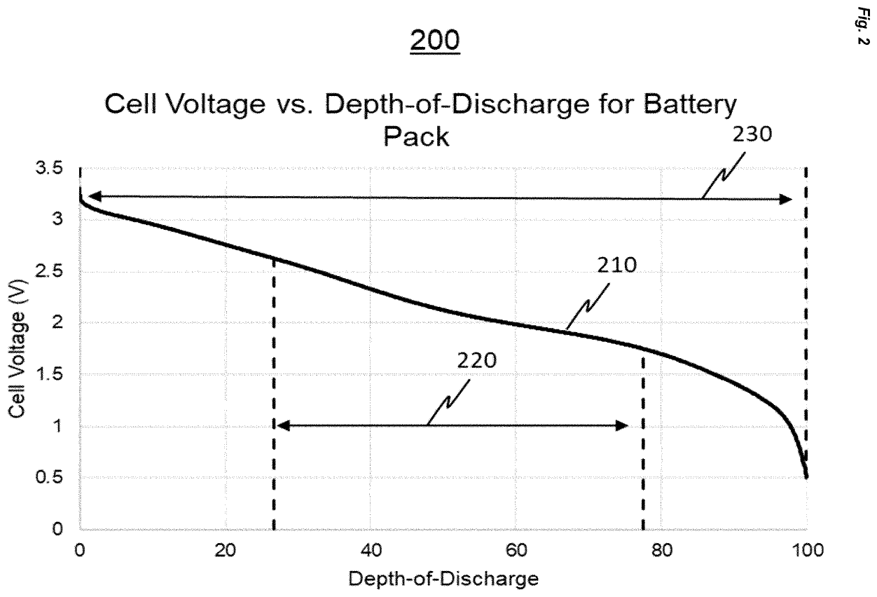

FIG. 2 depicts an example voltage profile 200 for the niobium-based cells used in the high-rate energy storage system 100 of FIG. 1 in accordance with one or more embodiments of the invention. The x-axis of the voltage profile 200 represents the “depth-of-discharge” for a battery cell and the y-axis represents the cell voltage (V) for the battery cell. As shown in the voltage profile 200, the discharge voltage curve 210 for the battery pack 102 is discharged from approximately 3.3V to 0.5V.

In some embodiments, a load that is coupled to the battery pack 102 may only accept an input voltage in a restricted or limited range. In this example, the load can accept a voltage that is within the range of 1.8V to 2.6V shown in the first range 220. As shown, the full range for the depth-of-discharge for each battery cell 104 is not used, resulting in inefficiencies. The high-rate energy storage system 100 such as that shown in FIG. 1 can be operated to capture a portion of the unused capacity of the battery cells that is outside of the input range of the load. For example, a second range 230 is able to be discharged from 3.3V to 0.5V.

Given the same voltage constraints that were considered for the first range 220, by incorporating the power conditioning circuit, e.g., the buck-boost converter, a complete utilization of the full depth-of-discharge of the individual cells can be achieved.

In order to recapture the upper range of the cells from approximately 3.3V to 2.5V, the battery initiates the buck operation mode of the buck-boost converter to reduce the input voltage to the desired output voltage level. To recapture the lower range of the cells from approximately 1.8V to 0.5V, the battery uses the boost operation mode of the buck-boost converter to increase the voltage to the desired output voltage level. The high-rate energy storage system 100 thus permits utilization of the full discharge of the niobium oxide-based cell, shown graphically as the difference between the first range 220 and the second range 230. The useable energy of the battery cells 104 is increased.

In some embodiments, the power conditioning circuit does not condition the input voltage for a portion of the input voltage range. As a result, the output voltage to the load equals the input voltage of the cell within this portion of the input voltage range. For example, the power conditioning circuit may not condition the input voltage for a portion of the voltage range from 1.8V to 2.5V.

The power conditioning circuit may only condition power at the upper or lower end of the input voltage range. In some embodiments, the power conditioning circuit only uses a buck operation mode of the converter to reduce the input voltage to the desired output voltage level to the load. In other embodiments, the power conditioning circuit only uses a boost operation mode of the converter to increase the input voltage to the desired output voltage level to the load.

Preferably, the power conditioning circuit conditions power at the upper and lower end of the input voltage range. Preferably, the power conditioning circuit uses a buck operation mode of the converter to reduce the input voltage to the desired output voltage level to the load and uses a boost operation mode of the converter to increase the input voltage to the desired output voltage level to the load.

FIGS. 3-6 depict example architectures for the power conditioning circuit 110 of FIG. 1. The power conditioning circuit 110 can include DC-DC converters of various topologies such as but not limited to buck converters, boost converters, buck-boost converters, etc.

FIG. 3 depicts a boost converter circuit 300 that may be operated in the boost operation mode to increase or step up the output voltage Vout of the boost converter circuit 300. The boost converter circuit 300 includes an arrangement of circuit elements including but not limited to an inductor (L1), a switch (S1), and a diode (D1). A capacitor (C1) can be provided in parallel to the load to filter the output voltage Vout. The inductor L1 and the diode D1 are connected in series between the input and output of the boost converter circuit 300. The switch S1 may be implemented as a metal-oxide semiconductor device, Silicon Carbide (SiC) device, or Gallium Nitride (GaN) device. In other embodiments, the switch S1 may be implemented as other controllable devices such as bipolar junction transistors (BJT) devices, insulated gate bipolar junction transistors (IGBT) devices, or the like.

In one or more embodiments of the invention, a controller 306 is provided to control the operation of the boost converter circuit 300 that is coupled to the battery pack 302. The controller 306 may detect the input voltage Vin and the output voltage Vout which can be used to provide control signals (gate driver signals) to operate the switch S1. Also, it can be appreciated the controller 306 may detect other signals as inputs that are used to generate the gate drive signals such as the input or output currents. It should be understood that the controller 306 may be implemented as a pulse-width modulated (PWM) based controller, or the controller 306 may be implemented as a digital controller such as a micro-controller, a digital signal processor, or the like. The controller 306 may in addition or instead include computer software with algorithms configured to generate such timings to control the duty cycle and associated computer hardware, such as one or more data storage devices, processors, and input-output devices. The boost converter circuit 300 and the controller 306 are provided for illustrative purposes and is not intended to limit the scope of the various embodiments of the invention.

The controller 306 generates the control signals to control the output voltage Vout to a desired level. The control signals operate the ON/OFF time for the switch S1. The duty cycle is the portion of time the switch S1 is in the ON state relative to the period of the cycle. In a non-limiting example, a switch that is ON for 1 milli-second (ms) and OFF for 3 ms will have a duty cycle of 25%. The controller 306 can be configured to detect the per cell voltage for each of the battery cells in the battery pack 302, and use the input to modify the output voltage Vout.

During operation, when the controller 306 initially switches the switch S1, the inductor L1 will begin to store energy within its magnetic field. Subsequently, when the controller 306 switches the switch S1 Off, the energy stored in the magnetic field of the inductor L1 will increase the output voltage Vout. When the controller 306 switches the switch S1 back On, the energy is provided to the magnetic field from the battery pack 102 and energy stored in the capacitor C1 can be discharged into the load to maintain the desired output voltage Vout. The cycle can continue during the operation of the device at the load. The controller 306 controls the duty cycle of the switch S1 to maintain the desired output voltage Vout.

In one or more embodiments, the power conditioning circuit 110 is operable to increase the output voltage Vout provided to the load while discharging the plurality of connected cells when a per cell voltage of the plurality of connected cells is less than a first threshold voltage. In one or more embodiments of the invention, the per cell voltage may be detected by the controller 306 and used as an input for generating the gate drive signals to control the duty cycle of the switch S1. During the boost operation mode, the output voltage Vout may be controlled by the controller 306 to remain at a configurable level.

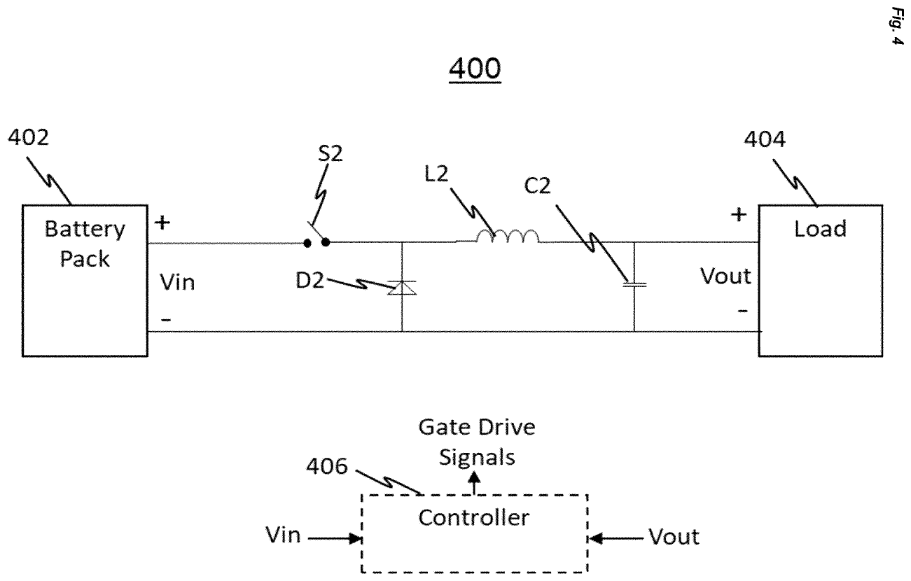

FIG. 4 depicts a buck converter circuit 400 that may be implemented as the power conditioning circuit 110 of the high-rate energy storage system 100 shown in FIG. 1. The buck converter circuit 400 coupled to the battery pack 402 may be operated by the controller 406 to reduce or step-down the output voltage Vout to a desired voltage for the load 404. As shown in FIG. 4, the buck converter circuit 400 includes an arrangement of circuit elements including but not limited to an inductor (L2), a switch (S2), and a diode (D2). A capacitor C2 is also provided at the output of the buck converter circuit 400 to filter the output voltage Vout for the load. FIG. 4 also shows a controller 406 which can include similar components as the controller 306 discussed with reference to FIG. 3.

During the initial operation, the controller 406 provides a gate drive signal to close the switch S2. The inductor L2 begins to store the energy in its magnetic field. When the switch S2 is closed the diode D2 is in the blocking mode and does not allow current to flow through it. As the inductor L2 stores the energy from the battery pack 102, the input voltage Vin is stepped-down and the output voltage Vout is approximated to be the difference between the input voltage Vin and the voltage across the inductor L2. When the switch S2 is opened, the inductor L2 and the capacitor C2 supplies the load 404 with the output voltage Vout. The controller 406 controls the duty cycle of the switch S3 to maintain the output voltage Vout in the desired voltage.

In one or more embodiments, the power conditioning circuit 110 is operable to decrease or step-down the output voltage Vout provided to the load 404 when a per cell voltage of the plurality of connected cells is greater than a second threshold voltage. With reference to the voltage profile 200, an example second threshold can be 3.3V for a load 404 that is restricted to receiving voltage at a pre-defined voltage. In one or more embodiments, when the per cell voltage for the plurality of cells reaches the second threshold, the buck operation mode of the buck converter circuit 400 can cease.

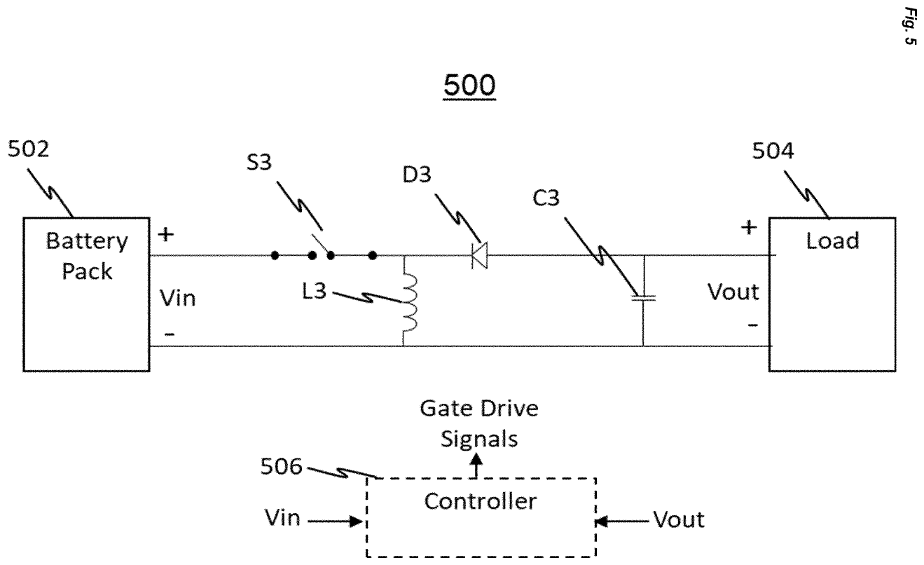

FIG. 5 depicts a buck-boost converter circuit 500 that can be operated to regulate the output voltage of the high-rate energy storage system 100 to a voltage range. The buck-boost converter circuit 500 can be operating in various modes. The buck-boost converter circuit 500 coupled to the battery pack 502 can be operated in a buck operation mode, the boost operation mode, and the buck-boost operation mode. In one or more embodiments, the buck-boost converter circuit 500 is operable to increase the output voltage provided to the load when a per cell voltage of the plurality of connected cells is less than a first threshold voltage, and is further operable to decrease the output voltage provided to the load when a per cell voltage of the plurality of connected cells is greater than a second threshold voltage.

The buck-boost converter circuit 500 includes an arrangement of circuit elements including but not limited to an inductor (L3), a switch (S3), and a diode (D3) as shown in FIG. 5. During operation when the controller 506 initially switches on the switch S3, the inductor L3 is charged by the battery pack 102 and the diode D3 is in the blocking mode. Subsequently, when the switch S3 is switched OFF, the load 504 and the capacitor C3 will be charged from the inductor L3. The diode D3 will be forward biased allowing current to flow through diode D3 and back to the inductor L3. When the switch S3 is switched ON, the inductor L3 will be charged again and the capacitor C3 can be discharged through the load 504 to maintain the output voltage Vout.

In one or more embodiments, the power conditioning circuit 110 may be operated by the controller 506 in a non-conditioning mode when the per cell voltage of the plurality of connected cells is between the first threshold voltage and the second threshold voltage. The output voltage Vout of the power conditioning circuit 110 may be in a range that is acceptable for the load 504 without any conversion of the voltage. In such a case, the controller 506 can be configured to allow power from the battery pack 102 to be coupled directly to the load 504 without conditioning.

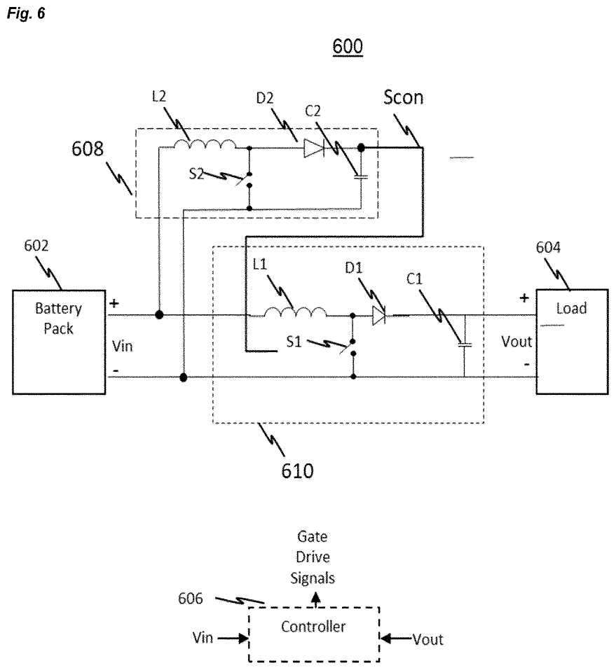

FIG. 6 depicts a dual-stage boost converter circuit 600 which may be operated to increase or step up the output voltage Vout of the dual-stage boost converter circuit 600 in cases where the input voltage Vin from the battery pack 602 is extremely low or below a lower threshold. This is advantageous compared to the conventional boost converter circuit 300 shown in FIG. 3 because it allows for operation under a wider range of battery voltages. For example, in a reference system, lithium-ion cells are operated in a range between 4.2V to 3V per cell. However, niobium-based cells can operate between 3.2V to 0.5V per cell.

In a reference boost converter circuit architecture, when the input voltage reaches a level that is less than a lower voltage threshold for each cell (e.g., 3V per cell for lithium-ion based battery cells), there may be insufficient power to operate the switches of the boost converter circuit. At this stage, the boost converter circuit may stop providing an output voltage to the load due to the limitations of the circuit. The architecture of the dual-stage boost converter circuit 600 described herein is provided to operate in a lower operating voltage range beyond the capabilities (e.g., less than 3V) of the existing boost converter architectures. Accordingly, the dual-stage boost converter circuit 600 may be operated by a controller 606 to increase the output voltage Vout to a desired voltage for the load 604 even when the per cell voltage for each battery cell is in the lower range.

With reference to FIG. 6, the dual-stage boost converter circuit 600 may comprise an arrangement of circuit elements including but not limited to two inductors (L1 and L2), two switches (S1 and S2), and two diodes (D1 and D2). Two capacitors (C1 and C2) may further be provided, where capacitor C1 is in parallel to the load 604 to filter the output voltage Vout and C2 is in parallel to the switch control signal (Scon) to filter the voltage used to power the switch S1. The inductor L1 and the diode D1 can be connected in series between the input and output of the primary sub-circuit 610, and the inductor L2 and diode D2 can be connected in series between the input and output of the control sub-circuit 608. The switches S1 and S2 may be implemented as metal-oxide semiconductor devices, Silicon Carbide (SiC) devices, or Gallium Nitride (GaN) devices. In other embodiments, the switches S1 and S2 may be implemented as other controllable devices such as bipolar junction transistors (BJT) devices, insulated gate bipolar junction transistors (IGBT) devices, or the like. Switches S1 and S2 need not be implemented as the same type of device.

The controller 606 may detect the input voltage Vin and the output voltage Vout which can be used to provide control signals (gate driver signals) to operate the switches S1 and S2. Also, it can be appreciated the controller 606 may detect other signals as inputs that are used to generate the gate drive signals, such as the input or output currents.

The controller 606 generates the control signals to control the output voltage Vout to a desired level. During operation, the controller 606 provides a gate drive signal to close switch S2 in the control sub-circuit 608. The inductor L2 then begins to store energy in its magnetic field. When switch S2 is closed, diode D2 is in blocking mode and does not allow current to flow through it. When the controller 606 switches switch S2 Off, the energy stored in the magnetic field of inductor L2 increases the output voltage of the control sub-circuit 608, which is carried via Scon and used as a signal to close switch S1 in the primary sub-circuit 610. Therefore, when the input voltage Vin is too low to power switch S1, since, for example, some metal-oxide semiconductor devices require a minimum operating voltage for operation, the primary sub-circuit 610 can still remain operational. In one or more embodiments of the disclosure, the control sub-circuit 608 is configured to operate at a lower operating voltage than an operating voltage of the primary sub-circuit 610. When the controller 606 switches switch S2 back On, the energy is provided to the magnetic field from the battery pack 602 and energy stored in the capacitor C2 can be discharged to Scon to maintain the desired output voltage and further to maintain the operation of the primary sub-circuit 610. This enables the primary sub-circuit 610 to be operated in a similar manner as the boost converter circuit 300 previously described in FIG. 3. The controller 606 may also control the duty cycle of switch S1 to maintain the desired overall output voltage Vout of the dual-stage boost converter circuit 600.

In one or more embodiments, the dual-stage boost converter circuit 600 is operable to increase the output voltage Vout provided to the load while discharging the cells of the battery pack 602 when a per cell voltage of the battery pack 602 is less than a first threshold voltage. In one or more embodiments of the invention, the per cell voltage may be detected by the controller and 606 used as an input for generating the gate drive signals to control the duty cycles of switches S1 and S2.

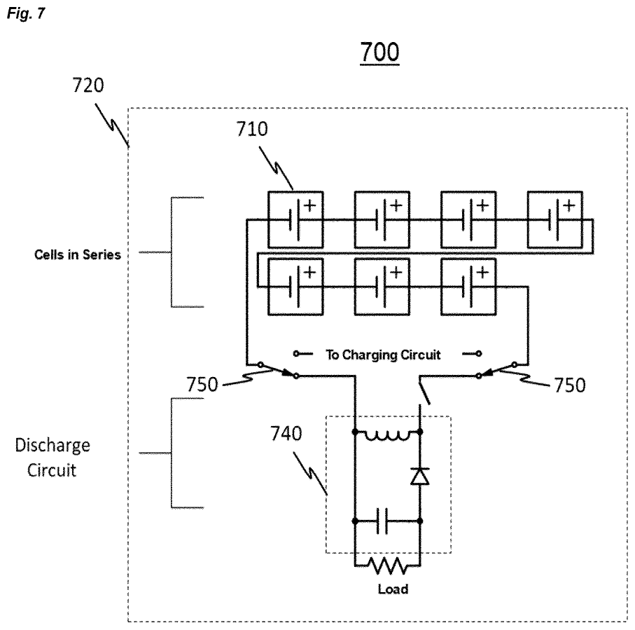

FIG. 7 depicts an architecture for a battery pack 700 that integrates a power conditioning circuit 710 within the housing of the battery pack 720 including a plurality of battery cells 730 that are coupled in series. Although the battery pack 700 depicts a buck-boost converter circuit 640 such as that shown in FIG. 5, it can be appreciated that different types of converters can be used and are not limited by the converter illustrated in FIG. 7. The battery pack 700 in this example includes 7 battery cells 710 that are connected in series and that are coupled to the buck-boost converter circuit 740 through switches 750. It can be appreciated that the battery pack 700 can include any suitable number of battery cells 710 and is not limited by the example. The battery pack 700 may provide a single integrated solution for a device where the power conditioning circuit is located within the battery pack 700 and can be located other than on the coupled device.

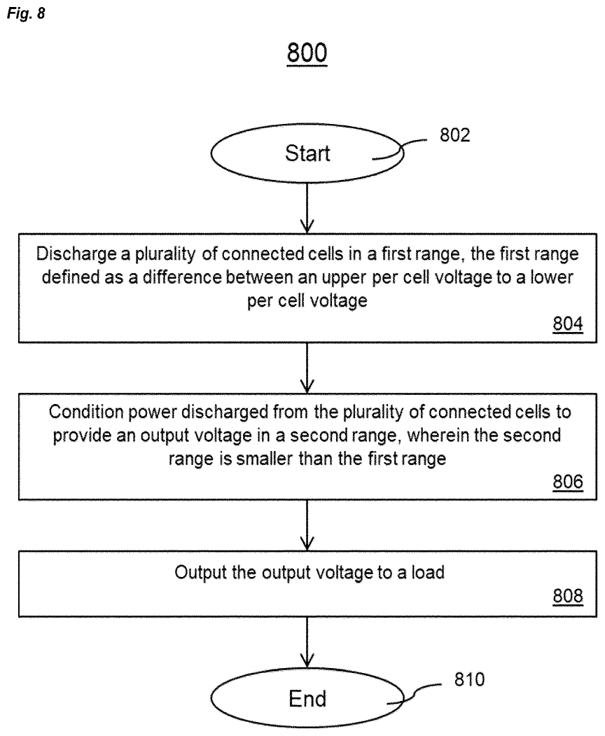

FIG. 8 depicts a flowchart of a method 800 for operating the high-rate energy storage system 100 such as that shown in FIG. 1. The method 800 begins at block 802 and proceeds to block 804 which provides for discharging, using a power conditioning circuit, a plurality of connected cells in a first range, the first range defined as a difference between an upper per cell voltage to a lower per cell voltage. The first range, in such a case, can be defined by an upper per cell voltage and a lower per cell voltage and is greater than that provided by lithium-ion battery cells with carbonaceous anodes. The power conditioning circuit is operable to condition the voltage received from the battery cells by increasing and/or decreasing the output voltage based on one or more thresholds. The power conditioning circuit is also operable to neither increase nor decrease the output voltage when the per cell voltage of each battery cell is between a first threshold and a second threshold for conditioning the voltage for the load.

Block 804 conditions power discharged from the plurality of connected cells to provide an output voltage in a second range, wherein the second range is smaller than the first range on a per cell basis. In one or more embodiments, the second range can correspond to an acceptable input voltage range for a load.

Block 806 outputs the output voltage to a load. The method 800 ends at block 808. The process flow diagram of FIG. 8 is not intended to indicate that the operations of the method 800 are to be executed in any particular order, or that all of the operations of the method 800 are to be included in every case. Additionally, the method 800 can include any suitable number of additional operations and is not limited by the operations shown in FIG. 8.

The high-rate energy storage system 100 including the niobium oxide-based battery cells and the power conditioning circuit improves over the prior art by enabling the discharge of the battery cells over a wider range than existing technologies, permitting use of a greater portion of energy available in the cells for applications which prefer an output voltage having smaller per cell range. The technical effects and benefits include improved utilization of the usable capacity in each of the battery cells which can provide a longer useful life for the battery cells.

Various embodiments are described herein with reference to the related drawings. Alternative embodiments can be devised without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

### REFERENCES

A number of publications are cited above in order to more fully describe and disclose the invention and the state of the art to which the invention pertains. Full citations for these references are provided below. The entirety of each of these references is incorporated herein.
EP 2685635
WO 2005/060023
US 2019/0305586
US 2017/0126131
US 2013/0320932
US 2013/0043839
US 2010/0156175
U.S. Pat. No. 7,702,369
US 2021/0218075

1. A battery comprising:
a plurality of connected cells;
a power conditioning circuit coupled to the plurality of connected cells,
wherein the power conditioning circuit is operable to discharge the plurality of connected cells in a first range, the first range defined as a difference between an upper per cell voltage to a lower per cell voltage,
wherein the power conditioning circuit is operable to condition power discharged from the plurality of connected cells to provide an output voltage in a second range, wherein the second range is smaller than the first range on a per cell basis; and
output terminals electrically connected to the power conditioning circuit for providing the output voltage to a load.

2. The battery of claim 1, wherein the first range is greater than or equal to 1.8V per cell, and
(i) the upper per cell voltage is 2.7V or more per cell and/or the lower per cell voltage is 0.7V or less per cell; or
(ii) the upper per cell voltage is 3.0V or more per cell and/or the lower per cell voltage is 0.5V or less per cell.

3. The battery of claim 1, wherein the second range is less than or equal to 1V per cell, wherein the output voltage in the second range is the difference between an upper per cell voltage output from the power conditioning circuit and a lower per cell voltage output from the power conditioning circuit, wherein the upper per cell voltage is 4.5V or less per cell and/or the lower per cell voltage is 2.7V or more per cell.

4. (canceled)

5. (canceled)

6. The battery of claim 3, wherein the upper per cell voltage output from the power conditioning circuit is 4.2V or less per cell and/or the lower per cell voltage output from the power conditioning circuit is 3.0V or more per cell.

7. The battery of claim 1, wherein the power conditioning circuit is:
(i) operable to discharge each cell of the plurality of connected cells from the upper per cell voltage of 3.3V per cell to the lower per cell voltage of 0.5V per cell; or
(ii) operable to discharge each cell of the plurality of connected cells from the upper per cell voltage of 3.7V per cell to the lower per cell voltage of 0.5V per cell;

8. The battery of claim 1, wherein the power conditioning circuit is:
(i) operable to increase the output voltage provided to the load while discharging the plurality of connected cells when a per cell voltage of the plurality of connected cells is less than a first threshold voltage; and/or
(ii) operable to decrease the output voltage provided to the load when a per cell voltage of the plurality of connected cells is greater than a second threshold voltage.

9. The battery of claim 8, wherein the power conditioning circuit is in a non-conditioning mode when the per cell voltage of the plurality of connected cells is between the first threshold voltage and the second threshold voltage.

10. The battery of claim 7, wherein the first threshold voltage is from 1.5 to 2V, and wherein the second threshold voltage is from 2.5 to 3V.

11. The battery of claim 1, wherein each cell of the plurality of cells comprises a niobium oxide material as an electrode active material, wherein the niobium oxide material is the anode during discharge of the cell.

12. (canceled)

13. (canceled)

14. The battery of claim 11, wherein the niobium oxide material is a niobium metal oxide selected from Nb₁₆W₅O₅₅, Nb₁₈W₁₆O₉₃ and combinations thereof.

15. (canceled)

16. (canceled)

17. (canceled)

18. The battery of claim 1, wherein the power conditioning circuit comprises a buck converter and the buck converter is operable to decrease the output per cell voltage to the load compared to the per cell voltage of the plurality of connected cells.

19. The battery of claim 1, wherein the power conditioning circuit comprises a boost converter and the boost converter is operable to increase the output per cell voltage to the load compared to the per cell voltage of the plurality of connected cells.

20. The battery of claim 19, wherein the boost converter is a dual-stage boost converter, the dual-stage boost converter comprising:
a controller; and
a first boost converter and a second boost converter that are coupled to the plurality of connected cells and are in parallel to each other, wherein the first boost converter and the second boost converter are operably coupled to the controller,
wherein the first boost converter is configured to generate a power signal to operate the second boost converter,
wherein the second boost converter is configured to boost an input voltage from the power source to provide an output voltage to a load when the second boost converter receives the power signal from the first boost converter.

21. The battery of claim 20, wherein the first boost converter is configured to generate the power signal to operate the second boost converter when the input voltage of the plurality of connected cells is between an upper per cell voltage and a lower per cell voltage.

22. The battery of claim 21, wherein:
(i) the upper per cell voltage is at least 2.7V per cell and the lower per cell voltage is 0.5V to 0.7V per cell;
(ii) the upper per cell voltage is at least 3.3V per cell and the lower per cell voltage is 0.5V to 0.7V per cell; or
(iii) the upper per cell voltage is at least 3.7V per cell and the lower per cell voltage is 0.5V to 0.7V per cell.

23. (canceled)

24. A method of discharging a battery, the method comprising:
discharging, using a power conditioning circuit, a plurality of connected cells in a first range, the first range defined as a difference between an upper per cell voltage to a lower per cell voltage;
conditioning power discharged from the plurality of connected cells to provide an output voltage in a second range, wherein the second range is smaller than the first range on a per cell basis; and
outputting the output voltage to a load.

25. The method of claim 24, wherein the first range is greater than or equal to 1.8V per cell, and for the first range:
(i) the upper per cell voltage is 2.7V or more per cell and/or the lower per cell voltage is 0.7V or less per cell; or
(ii) the upper per cell voltage is 3.0V or more per cell and/or the lower per cell voltage is 0.5V or less per cell.

26. The method of claim 24, wherein the second range is less than or equal to 1V per cell, wherein the second range is defined as a difference between an upper per cell voltage provided to the load and a lower per cell voltage provided to the load, wherein for the upper per cell voltage provided to the load is 4.5V or less per cell and/or the lower per cell voltage provided to the load 2.7V or more per cell.

27. (canceled)

28. (canceled)

29. The method of claim 24, further comprising:
(i) discharging each cell of the plurality of connected cells from the upper per cell voltage of 3.3V per cell to the lower per cell voltage of 0.5V per cell; or
(ii) discharging each cell of the plurality of connected cells from the upper per cell voltage of 3.7V per cell to the lower per cell voltage of 0.5V per cell.

30. The method of claim 24, wherein
conditioning the power comprises:
(i) increasing the output voltage provided to the load while discharging the plurality of connected cells when a per cell voltage of the plurality of connected cells is less than a first threshold voltage; and/or
(ii) decreasing the output voltage provided to the load when a per cell voltage of the plurality of connected cells is greater than a second threshold voltage.

31. The method of claim 30, further comprising operating the power conditioning circuit in a non-conditioning mode when the per cell voltage of the plurality of connected cells is between the first threshold voltage and the second threshold voltage.

32. The method of claim 30, wherein the first threshold voltage is from 1.5 to 2V and wherein the second threshold voltage is from 2.5 to 3V.

33. The method of claim 24, wherein each cell of the plurality of cells comprises a negative active material comprising a niobium oxide, a niobium metal oxide, or a combination thereof.
